(19) United States
(12) Patent Application Publication
(10) Pub. No.: US 2006/0274529 A1
(43) Pub. Date: Dec. 7, 2006

(54) LED light bulb

(75) Inventor: Densen Cao, Sandy, UT (US)

Correspondence Address: Parsons Behle & Latimer;Suite 1800, 201 South Main Street, P.O. Box 45898, Salt Lake City, UT, 84111, US

(73) Assignee: Cao Group, Inc.

(21) Appl. No.: 11/444,166

(22) Filed: May 31, 2006

Related U.S. Application Data
(60) Provisional application No. 60/686,262, filed on Jun. 1, 2005.

(51) Int. Cl. F21V 29/00

(52) U.S. Cl. 362/294; 362/345; 362/308

(57) ABSTRACT

An LED light bulb can include a unitary casing that serves many functions, such as mounting platform for the light source, as heat sink, as heat dissipater with cooling fins, as the mounting structure for a light reflector, as the mounting structure for the lens, as the mounting structure for the connector, as the housing for the light bulb, and as the gripping surface for installation of the light bulb into a light socket. The casing has two separate cavities, one for installation of the LED light source, reflector and lens, and another for installation of control circuitry. A connection fitting may be included.

### CLAIM FOR PRIORITY

This application claims benefit of and priority to U.S. Provisional Patent Application Ser. No. 60/686,262 filed on Jun. 1, 2005, which is hereby incorporated by reference.

### BACKGROUND

There is a need for LED light bulbs which provide a sufficiently powerful focused light beam.

### BRIEF DESCRIPTION OF DRAWINGS

FIG. 1a depicts a perspective view of an example LED light bulb.

FIG. 1b depicts a simplified cross section of the light bulb of FIG. 1a.

FIG. 1c depicts a detailed cross section of the light bulb of FIG. 1a.

### DETAILED DESCRIPTION

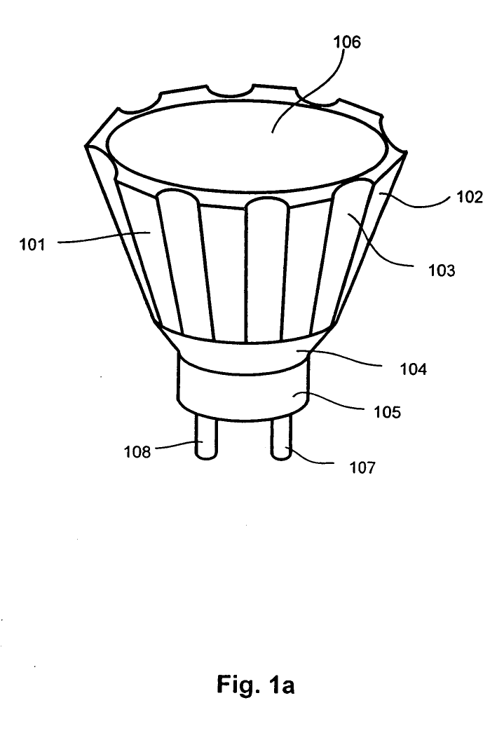

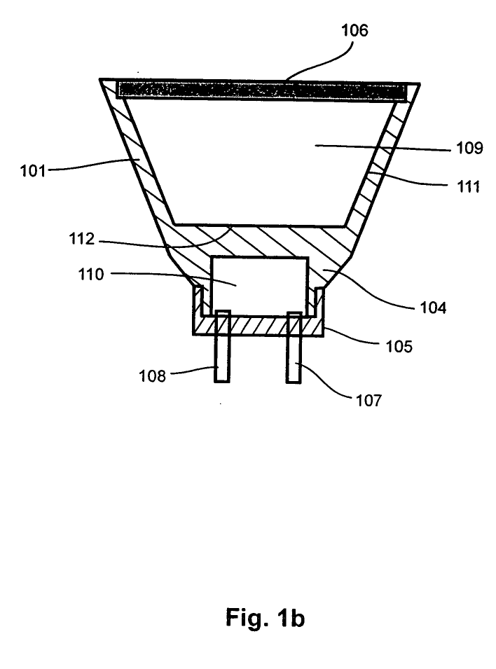

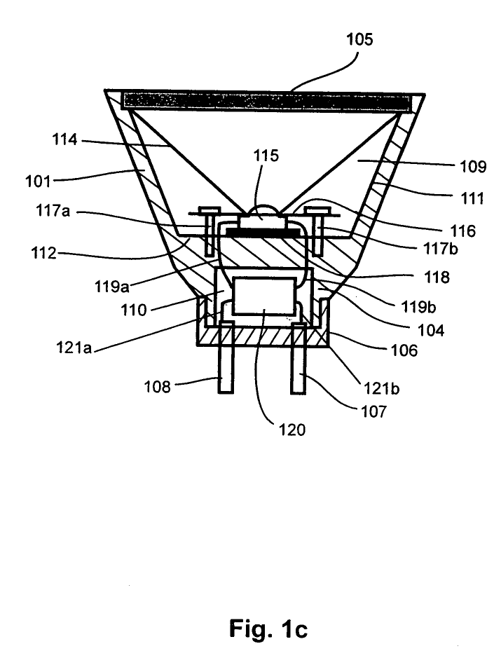

FIG. 1a depicts a perspective view of an example LED light bulb. It includes a casing 101. The casing can be made from a heat sink material, such as a metal (including Cu and Al), heat-conductive plastic, ceramic, or other heat conductive materials. The casing 101 has a radial exterior periphery with a plurality of peaks 102 and valleys 103 which increase the surface area for efficient heat dissipation. The casing can be a conical shape, a cylindrical shape, or any regular or irregular geometric or other shape. On the bottom (proximal side) of the casing 101 there is a neck structure 104 at which the casing reduces in size to accommodate a connection fitting 105. There is a lens 106 on top of (distal side) the casing 101. The lens shapes a beam of light emitted from the casing. The lens can be of any desired configuration to achieve desired light density and footprint shape. Examples of lens that may be used include a concave lens, a convex lens, a flat lens, a Fresnel lens, a multi-focal lens, a converging prism, a diverging prism, a double concave lens, a double convex lens, a spherical lens, a plano-convex lens, a plano-concave lens, a meniscus lens, or other lens as desired. The connection fitting 105 can be any desired fitting, such as two-pin (107 and 109), MR16, or Edison-style.

FIG. 1b depicts a simplified cross section of the light bulb of FIG. 1a. In FIG. 1b, the casing 101 is shown in greater detail. The casing 101 includes cavity 109 and cavity 110. Cavity 110 is a receptacle for control circuitry. Cavity 109 is a receptacle for a light source and light reflector. Cavity 109 has a bottom (proximal) surface 112 which is generally flat and which is approximately where a light source may be placed. Surface 111 is annular, and in this example conical annular. Note that casing 111 is a unitary structure that serves as mounting platform for the light source, as heat sink, as heat dissipater with cooling fins, as the mounting structure for a light reflector, as the mounting structure for the lens, as the mounting structure for the connector, as the housing for the light bulb, and as the gripping surface for installation of the light bulb into a light socket.

FIG. 1c depicts a more detailed cross-sectional view of the light bulb of FIG. 1a. In addition to the components described in the text associated with FIGS. 1a and 1b, there is a reflector 114 inside cavity 109. The reflector gathers light emitted by an a LED light source 115 and reflects it through lens 105. Instead of reflector 114, it would be possible to make surface 111 reflective. The reflector can be of any desired shape, such as conical, parabolic or otherwise. The reflector can be balanced with the lens so that the combination of light reflective properties of the reflector and the light bending properties of the lens generate a desired light footprint and light density for the application of the LED light bulb. The LED light source 115 can have a desired light profile which can be balanced with the properties of the reflector and the lens to achieve desired light beam density and footprint.

The LED light source 105 is attached to mounting surface 112. Attachment may be achieved by any desired method, including using a fixture plate and screws 117a and 117b. Optionally, a heat conduction paste 118 can be placed between the LED 115 and the casing surface 112. The combination of LED light beam profile, shape of reflector 114, and physical character of lens 105 determines the light beam shape. With the mechanical fixture structure, the LED can be replaced if it is out of service. The LED light source 105 can be of any desired configuration, such as an LED on a heat sink and covered with a cover or dome. The LED can be a single LED, an LED array chip, or an array of LED chips, as desired. Electrodes of the LED light source 115 are connected to a control board 120 through connection wires 119a and 119b. 120 located inside cavity 110. The control board 120 acts to regulate input voltage and current to satisfy the requirements of the LED light source.

While the present invention has been described and illustrated in conjunction with a number of specific embodiments, those skilled in the art will appreciate that variations and modifications may be made without departing from the principles of the invention as herein illustrated, described, and claimed. The present invention may be embodied in other specific forms without departing from its spirit or essential characteristics. The described embodiments are to be considered in all respects as only illustrative, and not restrictive. All changes which come within the meaning and range of equivalency of the claims are to be embraced within their scope.

1. An LED light bulb comprising:
unitary casing,
aid unitary casing being a continuous, one-piece formation,
aid casing serving as a heat sink for an LED light source,
aid casing being made from a heat-conductive material,
plurality of peaks and valleys located on the exterior of said casing,
aid peaks and valleys serving as cooling fins,
aid casing serving as a heat dissipator,
first and second cavities located within said casing,
said first cavity having a flat proximal surface and an annular interior surface,
an LED light source mounted in said first cavity on said proximal surface,
a light reflector located in said first cavity,
said light reflector serving to gather light emitted by said lights source and reflect it toward said casing distal side,
a control panel for said LED light source mounted in said second cavity, and
a lens at said first cavity distal side,
said lens and said light reflector being balanced to create a light beam of desired density and having a desired light footprint.

2. A device as recited in claim 1 wherein said LED light source includes a heat sink, an LED chip mounted to said head sink, and a dome over said LED chip.

3. A device as recited in claim 1 wherein said casing is made at least in part from Cu.

4. A device as recited in claim 1 wherein said casing is made at least in part from Al.

5. A device as recited in claim 1 wherein said light source includes only a single LED chip.

6. A device as recited in claim 1 wherein said light source includes an array of LED chips.

7. A device as recited in claim 1 wherein said light source includes an LED chip array.

8. A device as recited in claim 1 wherein said light source has a light profile which is balanced with said light reflector and said lens to achieve a desired light beam density and footprint.

9. A device as recited in claim 1 wherein said unitary casing serves all of the functions of being a mounting platform for the light source, being a heat sink, being a heat dissipater, being a mounting structure for the light reflector, being a mounting structure for the lens, being a mounting structure for a connector, being a housing for the light bulb, and providing a gripping surface for installation of the light bulb into a light socket.

10. A device as recited in claim 1 further comprising:
a neck structure on said casing, said neck structure serving as a transition to a connection fitting.

11. A device as recited in claim 1 wherein said lens is a Fresnel lens.

12. A device as recited in claim 1 wherein said lens is selected from the group consisting of concave lenses, convex lenses, flat lenses, multi-focal lenses, converging prisms, diverging prisms, double concave lenses, double convex lenses, spherical lenses, piano-convex lenses, plano-concave lenses, and meniscus lenses.

13. A device as recited in claim 1 further comprising a mounting plate for mounting said LED light source to said casing.

14. A device as recited in claim 13 further comprising a plurality of screws for affixing said mounting plate and said LED light source to said casing.

15. A device as recited in claim 1 further comprising a quantity of heat conductive past located between said LED light source and said casing.
